(19) United States
(12) Patent Application Publication
(10) Pub. No.: US 2026/0356285 A1
(43) Pub. Date: Nov. 12, 2026

(54) VEHICLE LIGHT COMMUNICATION

(71) Applicant: Ford Global Technologies, LLC, Dearborn, MI (US)

(72) Inventor: Tahiry Lizeth Romano, México City/México (MX)

(73) Assignee: Ford Global Technologies, LLC, Dearborn, MI (US)

(21) Appl. No.: 19/200,749

(22) Filed: May 7, 2025

(51) Int. Cl. B60Q 1/50; B60Q 1/46

(52) U.S. Cl. CPC B60Q 1/543; B60Q 1/46

(57) ABSTRACT

A component of a vehicle can be determined to be impaired. A light of the vehicle can then be actuated in a pattern corresponding to the component of the vehicle that is impaired, wherein the light is arranged to be visible to a second vehicle.

### BACKGROUND

Ground vehicles can operate under a variety of environmental conditions that can affect operation of the vehicle, such as an amount of moisture, rain, snow, slush, etc., on the ground surface, a humidity level, an amount of ambient light, etc. Vehicle sensors can be affected by environmental conditions. For example, optical or visible light spectrum cameras may have difficulty “seeing” under conditions such as fog, snow, etc.

### BRIEF DESCRIPTION OF THE DRAWINGS

FIG. 1 is a diagram of an example vehicle system.

FIG. 2 is a diagram of an example process for actuating one or more lights on a vehicle to indicate a determined impairment of a component (or components) of the vehicle 105.

### DESCRIPTION

### Introduction

Described herein are techniques for a vehicle to utilize light-based communications. In examples, a vehicle computer can detect that a vehicle's driver assistance system is impaired. For example, vehicle sensors may be unable to obtain data to support operation of the driver assistance system due to environmental conditions such as fog or snow. In such situations, one or more lights in or on the vehicle can be actuated so as to be viewable by observers outside of the vehicle, for example, in other vehicles. The lights can be actuated at patterns and/or intensities to indicate an impairment of one or more driver assistance systems.

In accordance with the present disclosure, a system comprises a processor and a memory, the memory storing instructions executable by the processor, including instructions to determine that a component of a vehicle is impaired; and then actuate a light of the vehicle in a pattern corresponding to the component of the vehicle that is impaired, wherein the light is arranged to be visible to a second vehicle.

Further, a method comprises determining that a component of a vehicle is impaired; and then actuating a light of the vehicle in a pattern corresponding to the component of the vehicle that is impaired, wherein the light is arranged to be visible to a second vehicle.

A basis for determining that the component of the vehicle is impaired can include data about an environment around the vehicle. The light can be actuated based on a location of the vehicle in addition to determining that the component of the vehicle is impaired.

The component that is impaired can be a vehicle driver assistance system. The pattern can be one of a plurality of stored patterns that respectively correspond to a plurality of driver assistance systems including the driver assistance system. The light can be actuated in the pattern and in a second pattern, wherein the second pattern corresponds to a second driver assistance system that is impaired.

The component that is impaired can be a vehicle sensor, and determining that the component is impaired can include determining that a quality of sensor output is below a quality threshold. The quality of sensor output can describe output from a camera, a radar, or a lidar.

The instructions can include instructions to actuate the light and a second light of the vehicle in the pattern corresponding to the component of the vehicle.

The light can be mounted at an exterior of the vehicle.

### Example System

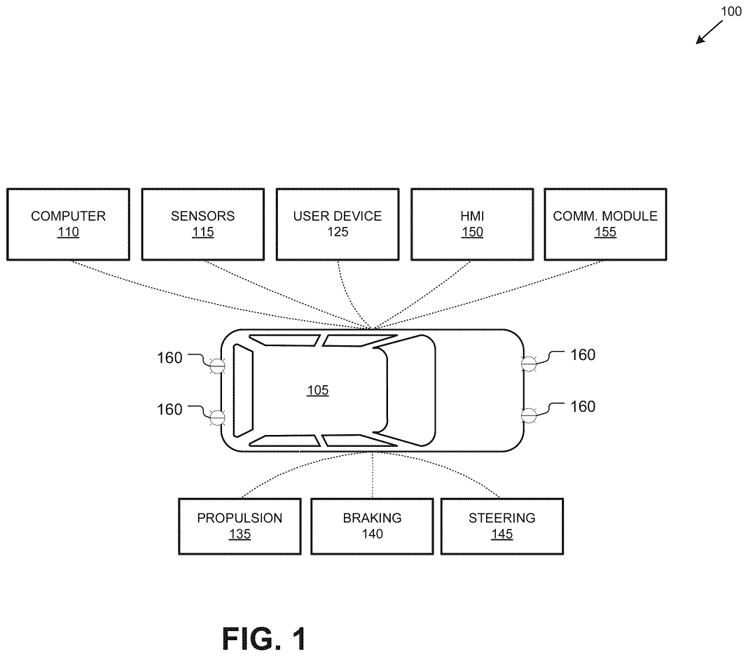

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a handheld portable device while driving a vehicle due to safety concerns, it is expected that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form such as by geo-coordinates such as latitude and longitude coordinates obtained via a navigation system that uses a global navigation satellite system (GNSS) such as the Global Positioning System (GPS) system. Further examples of vehicle data can include measurements of vehicle systems and components (e.g., a vehicle speed or velocity, a level of fuel in a fuel tank, an amount of available electric charge, etc.).

A computer 110 can be provided to control one or more vehicle operations including steering, acceleration, speed control, and/or braking. Accordingly, system 100 is shown comprising vehicle 105 which may include Driver Assistance System (DAS) features. A computer 110 (e.g., one or more vehicle 105 electronic control units, i.e., ECUs) can be configured to operate the vehicle 105 independently of operation by an occupant with regard to certain features. A computer 110 may be programmed to provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the computer 110 could provide hand-free driving in combination with ACC such that the computer 110 controls steering, braking and acceleration. In another example, the computer 110 could provide ACC and require hands-on operation. The computer 110 may be programmed to operate a powertrain propulsion system 135, a braking system 140, a steering system 145, a device screen that displays a Human Machine Interface (HMI) 150, and/or other vehicle systems.

A computer 110 is generally programmed for communications on a vehicle network (not shown), for example, a conventional vehicle communications bus such as a Controller Area Network (CAN) bus, a Local Interconnect Network (LIN) bus, etc., and/or other wired and/or wireless technologies such as Bluetooth®, Wi-Fi®, Ethernet, etc. via the network, bus, and/or other wired or wireless mechanisms (e.g., a wired or wireless local area network in the vehicle 105), the computer 110 may transmit messages to various devices in the vehicle 105 and/or receive messages from the various devices such as sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation such as an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies such as cellular, Bluetooth®, Bluetooth® Low Energy (BLE), wired and/or wireless packet networks, etc.

The memory can be of any type, for example hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, for example over a CAN bus, a wireless network, etc. Alternatively or additionally, the memory can be part of the computer 110 (e.g., as a memory of the computer 110).

Sensors 115 can include a variety of devices. For example, various controllers in a vehicle 105 may operate as sensors 115 to provide data via the vehicle network or bus such as data relating to vehicle speed, acceleration, location, subsystem and/or component status, etc. Further, other sensors 115 could include cameras, motion detectors, etc. (i.e., sensors 115 may provide data for evaluating a status of a component, evaluating a slope of a roadway, etc.). The sensors 115 could, without limitation, also include short range radar, long range radar, light detection and ranging (LIDAR), ultrasonic transducers, and the like. Cameras can include optical cameras (e.g., in the visible spectrum), and/or other kinds of cameras such as time-of-flight, infrared, etc.

In one example, the vehicle 105 includes one or more thermal camera sensors 115. Thermal cameras, one type being far-infrared cameras, can be used to detect animals in both low light and light-obscured conditions. Thermal cameras provide images in various lighting conditions (night, sun glare, etc.) and weather conditions (fog, rain, etc.) that can be superior to the contrast provided by cameras limited to the visible light region.

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 includes vehicle components. In this context, a “component” is a part of a vehicle, or parts of a vehicle that operate cooperatively to perform a vehicle function. For example, a vehicle sensor 115 is a component, as is a braking subsystem, as is a driver assistance system. A vehicle component may include one or more hardware components adapted to perform a mechanical function or operation—such as moving the vehicle 105, slowing or stopping the vehicle 105, steering the vehicle 105, etc. Non-limiting examples of components include a powertrain propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices such as electronic control units (ECUs) or the like and/or computing devices such as described above with respect to the computer 110, and that likewise communicate via a vehicle network.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network; for example, the HMI 150 can send a message including the user input provided via a touchscreen, microphone, a camera that captures a gesture, etc., to a computer 110, and/or can display output such as via a screen, speaker, etc.

In addition, the vehicle computer 110 may be configured for communicating via a vehicle-to-vehicle communication module 155 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer (typically via direct radio frequency communications)). The communications module 155 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 155 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 155 according to any suitable short-range communications mechanism (e.g., DSRC, cellular, or the like).

The vehicle 105 includes one or more lights 160, that is, any suitable device that emits visible light. The computer 110 may control or direct a pattern or patterns of light emissions from the one or more lights 160, as described further below. Typically, a light 160 is arranged so as to be visible to other vehicles, that is, the light 160 typically emits electromagnetic radiation in the visible spectrum and directed outside of the vehicle 105. Typically, the light 160 is mounted at an exterior of the vehicle 105. A light 160 could be a lamp or lamps such as may be presently included on a vehicle for headlamps, tail lamps, warning lights, and so forth. In some examples the light 160 is a dedicated lamp or lamps for providing output as described herein indicating impairment of a vehicle component. For example, lights 160 could be mounted to a rear surface, such as a bumper or fascia or the like, of a vehicle 105 to provide communications to other vehicles rear of the vehicle 105. Similarly, one or more lights 160 could be mounted to a front or sides of the vehicle 105.

### Implementation Examples

The vehicle computer 110 memory typically stores instructions to determine that a component of a vehicle 105 is impaired; and then actuate a light 160 of the vehicle 105 in a pattern corresponding to the component of the vehicle that is impaired, wherein the light 160 is arranged to be visible to an observer outside of the vehicle 105, such as an observer in a second vehicle. Impaired components can be, for example, driver assistance systems or sensors 115. Herein, that a component is “impaired” means that the component has output an indication that the component is not operating within normal or usable parameters (for example, a component could output a message on a vehicle network that it is disabled or inactive), and/or data from the component has been determined to be below a quality or confidence threshold according to a suitable technique for analyzing the data, such as determining that the quality of images from a camera sensor 115 is below a threshold, and/or that environmental conditions are detected (e.g., snow, fogs, etc.) that are associated in a memory of the computer 110 with impairment of the component (e.g., fog could be associated with impairment of a vision sensor 115 and/or a lane-keeping DAS).

In an example, the component of the vehicle that is impaired is a vehicle driver assistance system. Herein, a “driver assistance system” means a system in the vehicle 105 in which the vehicle computer 110 or some other computer in the vehicle 105 (such as another ECU) provides control of at least one of propulsion, braking, and steering, and/or provides output such as via an HMI 150. Example driver assistance systems include, without limitation adaptive cruise control in which a computer provides control over vehicle 105 speed, lane keeping assistance in which a computer provides control over vehicle 105 steering, blind spot detection, in which a computer provides output related to objects in a vehicle operators blind spot or spots, automatic emergency braking, in which a computer applies breaking based on object detection, traffic sign recognition, in which a computer may process data such as image data to identify and display on a vehicle HMI 150 traffic sign information, and parking assistance in which a computer may control steering, propulsion, and/or braking to perform or assist in parking a vehicle 105.

The computer 110 can determine that a driver assistance system is impaired based on output from the driver assistance system. For example, an ECU or the like associated with the driver assistance system could provide output via a vehicle network indicating that the driver assistance system is disabled or unable to operate. For example, a lane keeping assist system could determine that lane lines or lane boundaries cannot be identified based on data from sensors 115 with sufficient confidence, and could output an indicator on a vehicle network (e.g., a CAN bus or the like) that the lane keeping assist system is disabled or not operating. Alternatively or additionally, the computer 110 could determine that a confidence in data from a sensor 115 needed for the driver assistance system was below a threshold. Any suitable technique for determining confidence in sensor data could be used, for example, techniques that analyze image data to determine whether lane lines can be discerned with sufficient confidence could be employed. On determining that sensor data needed to support the driver assistance system was below a confidence threshold, the computer 110 could determine that the driver assistance system is impaired.

Moreover, the component of the vehicle that is determined to be impaired could be a sensor 115. Determining that the sensor 115 is impaired could include a suitable technique for determining confidence in output of the since her 115, and then determining that the confidence is below a predetermined threshold. Alternatively or additionally, the computer 110 could rely on data provided by the sensor 115 or a controller thereof available on a vehicle network such as a CAN bus. For example, the sensor 115 could output data indicating whether data from the sensor 115 was available or not available to a driver assistance system. In examples, the sensor 115 outputs data on the vehicle network specifying that the sensor is or is not available, that is, outputs a binary flag. For example, a radar sensor 115 could output a message on a CAN bus indicating that it is available or not available (or active or inactive, etc.). Alternatively or additionally other sensors 115, such as visible light cameras or lidars, could output such indicators or flags.

In examples, a basis for determining that the component of the vehicle is impaired could include data about an environment around the vehicle. For example, a vehicle 105 could include a sensor 115 that can output data indicating a presence of an environmental condition such as a fog sensor that indicates a presence of fog that could affect vehicle operation, a precipitation sensor that indicates a presence of rain or other precipitation, etc. Output from such an environmental sensor could then be used to determine that a vehicle component is to be deemed impaired, and to then to actuate a light 160. The computer 110 could store a mapping of various environmental conditions to respective determinations that a vehicle component is impaired. For example, a determination of a fog condition, such as from output of a fog sensor, a determination from image sensor data that a fog condition exists, etc., could be mapped to a determination that one or more vehicle components, such as a lane keeping assist system or a blind spot detection system, etc., is impaired.

In examples, a basis for determining that the component of the vehicle is impaired could alternatively or additionally include crowd-sourced data. For example, via the communication module 155, the computer 110 could be in communication with a remote server (which could be referred to as a “cloud server”) that's provided data about environmental conditions and/or predicted impairment of a vehicle component. The vehicle 105 could be traveling on a road that other vehicles have recently traveled, the other vehicles providing data to the cloud server indicating impairment of components, such as fog or snow conditions and/or indications that a particular DAS was disabled due to conditions (e.g., that a lane keeping system was disabled due to poor visibility). In this situation, the cloud server could provide to the computer 110 data indicating that one or more components should be treated as impaired. The computer 110 could then determine that the component or components are impaired based on the data from the cloud server, possibly in combination with output from vehicle components such as described above. For example, if the cloud server indicated a likely fog condition and a fog sensor indicated a likelihood of fog, the vehicle computer 110 could determine an impairment of a lane keeping DAS.

In examples, actuating a light 160 could be based on a location of the vehicle in addition to determining that the component of the vehicle (such as a driver assistance system or a sensor 115) is impaired. A vehicle location may be provided in a conventional form such as by geo-coordinates such as latitude and longitude coordinates obtained via a navigation system that uses a global navigation satellite system (GNSS) such as the Global Positioning System (GPS) system. For example, a vehicle 105 could include a location sensor 115, for example, a sensor 115 that specifies a location, that is, a geo-location, of a vehicle. For example, a geo-location can be specified according to the Global Positioning System (GPS). The vehicle 105 location could then be used to retrieve map data (e.g., from a memory of the computer 110) from which the computer 110 could classify a current location of the vehicle 105. For example, a classification of a vehicle location could indicate a type or category of ground surface on which a vehicle 105 is presently located, such as a highway, a city street, a parking lot, a driveway, etc.

A determination to actuate a light 160 could require that the computer 110 is programmed to actuate the light 160 at a current location of the vehicle 105 and/or that actuation of the light 160 is permitted at the current location of the vehicle 105. For example, if the vehicle 105 is in a parking lot or parking garage, the computer 110 could be programmed not to actuate the light 160 even if a driver assistance system, such as lane keeping assistance, was impaired. Similarly, the computer 110 could be programmed to only actuate a light 164 certain driver assistance systems, such as lane keeping assistance, when the vehicle 105 is on a road or highway. Further, a pattern of actuating a light 160 could be different at different locations for a same impaired component. For example, if a blind spot detection system component was impaired on a road or highway, the computer 110 could actuate a light 160 in a first pattern, for example, with a greater intensity so as to be visible, but at a less frequent interval. On the other hand, if the blind spot detection system component was impaired in a parking garage, the computer 110 might actuate the light 160 at a second pattern, for example, with a lesser intensity than in an outdoor environment such as on a road, but with a more frequent interval so as to communicate urgency to other vehicles and surrounding users.

The computer 110 can be programmed to actuate a light 160 in a pattern based on a driver assistance system and/or sensor 115 that is impaired. Typically the pattern is selected so as to be noticeably different from conventional warning blinkers or “flashers.” For example, the light 160 could include one or more light emitting diode (LED closed parentheses lamps and could include a pattern indicating impairment of a driver assistance system or sensor 115 that includes the light 160 being on and off (i.e., emitting and not emitting light) at slower or longer intervals than a conventional warning blinker. Moreover, intervals could be varied to indicate the driver assistance system or sensor, and/or colors or intensities of the light 160 could be varied.

The pattern of light emitted by a light 160 may be according to one of a plurality of stored patterns that respectively correspond to a plurality of driver assistance systems including the driver assistance system. That is, the computer 110 could store a mapping of driver assistance systems to respective light patterns. For example, impairment of a lane keeping assist system could be indicated by a pattern of actuating the light 160 to emit light for a first period of time, deactivating the light 160 for a second period of time, and then activating the light 160 to emit light for a third period of time that is shorter than either of the first or second periods of time. Further for example, impairment of a blind spot detection system could be indicated by a pattern of actuating the light 160 to emit light for a first period of time, deactivating the light 160 for a second period of time, and then activating the light 160 to emit light for a third period of time that is longer than either of the first or second periods of time. It is to be understood that many other examples of patterns for activating a light 160 are possible.

Further, the computer 110 could actuate a light 160 to emit light in first and second patterns, for example, consecutively, for first and second driver assistance systems determined to be impaired. For example, the computer 110 could activate the light 160 to indicate impairment of a lane keeping assist system and could then activate the light 160 to indicate impairment of a blind spot detection system. That is, instructions to actuate the light 160 could include instructions to actuate the light in a first pattern and in a second pattern, wherein the second pattern corresponds to a second driver assistance system that is impaired.

As mentioned above, the component that is impaired could be a vehicle sensor 115, and determining that the component is impaired could include determining that a quality of sensor output is below a quality threshold. For example, the quality of sensor output could describe output from a camera, a radar, or a lidar. In examples, therefore, the computer 110 could be programmed to actuate the light 160 in a pattern corresponding to the impaired sensor 115. That is, a pattern could indicate that one or more of vehicle image sensors are impaired, that vehicle radar is impaired, etc.

As mentioned above, a vehicle 105 can include more than one light 160. Accordingly, the computer can include instructions to actuate a plurality of lights 160, such as a first light 160 and a second light 160 of the vehicle in a pattern corresponding to the component of the vehicle. For example, impairment of a first driver assistance system such as a lane keeping assist system could include actuating a left rear light 160 and then a right rear light 160 of a vehicle 105 in a pattern, whereas impairment of a second driver assistance system could include actuating 1st the right light 160 of the vehicle 105, and then, perhaps in a different color, the light 160 of the vehicle in a second pattern that thus differs from the first pattern.

### Example Process

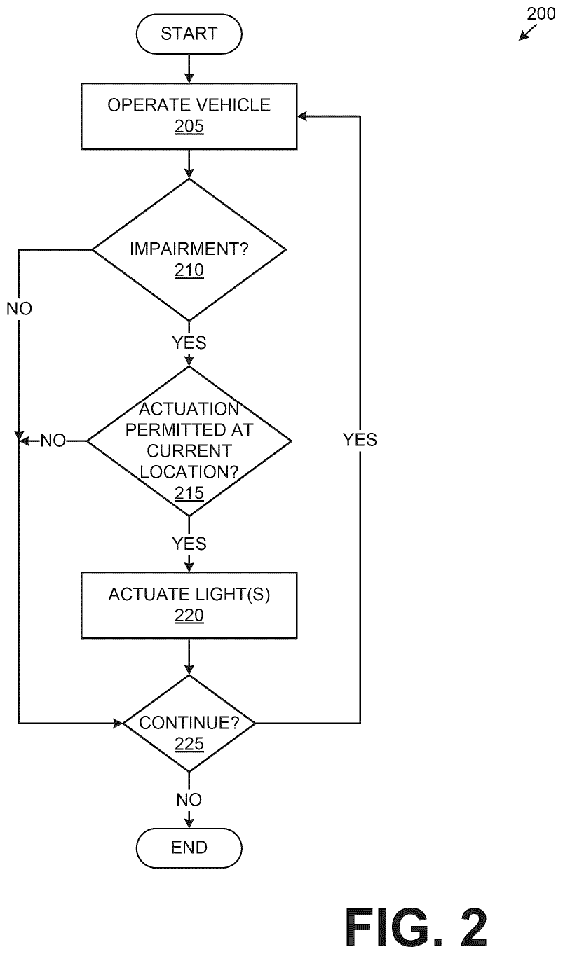

FIG. 2 is a diagram of an example process 200 for actuating one or more lights 160 on a vehicle 105 to indicate a determined impairment of a component (or components) of the vehicle 105, for example, to communicate the impairment to one or more other vehicles. Process blocks of the process 200 may be executed by a processor of a computer 110 according to instructions stored in a memory.

The process 200 begins in a block 205 in which the vehicle 105 is operated. In this context, to operate the vehicle 105 means that the vehicle 105 is powered on and a propulsion is activated and could be engaged to move the vehicle 105 (e.g., a vehicle 105 could be in “park” but the ignition is on and the vehicle 105 could be moved if shifted to a “drive” gear).

In a block 210, which is reached after the vehicle begins operating in the block 205, a determination is made whether a vehicle component is impaired. The determination can be made as described above. If a vehicle component is determined to be impaired, then a block 215 is executed next. Otherwise, the process 200 proceeds to the block 225.

In the block 215, the computer 110 determines whether actuation of the light 160 at a current location of the vehicle 105 is permitted. “Permitted” in this context means that actuating the light 160 is determined to be suitable for the current location, for example, that the computer 110 does not store programming or an indicator that a light 160 should not be actuated at the current location and/or that a light 160 should not be actuated at the current location for the currently determined component impairment. The block 215 could be omitted, but as discussed above, there may be locations of a vehicle 105 in which it is disadvantageous or not helpful to actuate a light 160. If it is permitted to actuate the light at the current location of the vehicle, then the process 200 proceeds to a block 220. Otherwise, the process 200 proceeds to a block 225.

In the block 220, the computer 110 actuates, or commands a controller to actuate, a light 160 based on the component impairment determined in the block 210. As discussed above, the light 160 (and possibly one or more second lights 160) can be actuated in a pattern to indicate the impaired component.

Following the block 220, after one or more lights 160 have been actuated, in a block 225, it is determined whether the process 200 is to continue. For example, the vehicle could be powered off, a user could deactivate lights 160, or the vehicle 105 could enter a location where light 160 actuation is no longer permitted. If the process 200 is to continue, then the process 200 returns to the block 205. Otherwise, the process 200 ends following the block 225.

### Concluding Remarks

Systems and methods described herein may be modified and/or omitted depending on the context, situation, and applicable laws, rules, and regulations. Further, regardless of actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions (e.g., from a memory, a computer readable medium, etc.), and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in above description of processing, one or more of the steps could be omitted, or the steps could be executed in a different order than shown and described. In other words, the descriptions of systems and/or processes herein are provided for the purpose of illustrating certain embodiments and should in no way be construed so as to limit the disclosed subject matter.

“Based on” means based at least in part on unless explicitly stated otherwise. That is, the phrase “based on” encompasses being partly or entirely based on. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise.

1. A system, comprising a processor and a memory, the memory storing instructions executable by the processor, including instructions to:
determine that a component of a vehicle is impaired; and
then actuate a light of the vehicle in a pattern corresponding to the component of the vehicle that is impaired and based on the current location of the vehicle, wherein the pattern is selected to be first pattern corresponding to the component for a first classification of the current location of the vehicle and selected to be a second pattern corresponding to the component for a second classification of the current location of the vehicle, wherein the light is arranged to be visible to a second vehicle.

2. The system of claim 1, wherein a basis for determining that the component of the vehicle is impaired includes data about an environment around the vehicle.

3. (canceled)

4. The system of claim 1, wherein the component that is impaired is a vehicle driver assistance system.

5. The system of claim 4, wherein the pattern is one of a plurality of stored patterns that respectively correspond to a plurality of driver assistance systems including the driver assistance system.

6. The system of claim 4, wherein the instructions to actuate the light include instructions to actuate the light include instructions to actuate the light in the pattern and in a second pattern, wherein the second pattern corresponds to a second driver assistance system that is impaired.

7. The system of claim 1, wherein:
the component that is impaired is a vehicle sensor, and
determining that the component is impaired includes determining that a quality of sensor output is below a quality threshold.

8. The system of claim 7, wherein the quality of sensor output describes output from a camera, a radar, or a lidar.

9. The system of claim 1, wherein the instructions include instructions to actuate the light and a second light of the vehicle in the pattern corresponding to the component of the vehicle.

10. The system of claim 1, wherein the light is mounted at an exterior of the vehicle.

11. A method, comprising:
determining that a component of a vehicle is impaired; and
then actuating a light of the vehicle in a pattern corresponding to the component of the vehicle that is impaired and based on the current location of the vehicle, wherein the pattern is selected to be first pattern corresponding to the component for a first classification of the current location of the vehicle and selected to be a second pattern corresponding to the component for a second classification of the current location of the vehicle, wherein the light is arranged to be visible to a second vehicle.

12. The method of claim 11, wherein a basis for determining that the component of the vehicle is impaired includes data about an environment around the vehicle.

13. (canceled)

14. The method of claim 11, wherein the component that is impaired is a vehicle driver assistance system.

15. The method of claim 14, wherein the pattern is one of a plurality of stored patterns that respectively correspond to a plurality of driver assistance systems including the driver assistance system.

16. The method of claim 14, wherein actuating the light includes actuating the light in the pattern and in a second pattern, wherein the second pattern corresponds to a second driver assistance system that is impaired.

17. The method of claim 11, wherein:
the component that is impaired is a vehicle sensor, and
determining that the component is impaired includes determining that a quality of sensor output is below a quality threshold.

18. The method of claim 17, wherein the quality of sensor output describes output from a camera, a radar, or a lidar.

19. The method of claim 11, further comprising actuating the light and a second light of the vehicle in the pattern corresponding to the component of the vehicle.

20. The method of claim 11, wherein the light is mounted at an exterior of the vehicle.
